(19) United States
(12) Patent Application Publication
(10) Pub. No.: US 2013/0037621 A1
(43) Pub. Date: Feb. 14, 2013

(54) COMPOSITIONS AND PROCESSES FOR DUST SUPPRESSION

(71) Applicants: Steven Joseph Wantling, Hoover, AL (US); Jason Lee Holder, Huntington, TX (US); Harden Christopher Wren, Lufkin, TX (US); Eduardo Romero Nochebuena, Porter, TX (US)

(72) Inventors: Steven Joseph Wantling, Hoover, AL (US); Jason Lee Holder, Huntington, TX (US); Harden Christopher Wren, Lufkin, TX (US); Eduardo Romero Nochebuena, Porter, TX (US)

(21) Appl. No.: 13/556,391

(22) Filed: Jul. 24, 2012

Related U.S. Application Data
(60) Provisional application No. 61/521,220, filed on Aug. 8, 2011.

(51) Int. Cl. C09K 3/22; B05B 17/00

(52) U.S. Cl. 239/1; 252/88.1

(57) ABSTRACT

Compositions for dust suppression, methods for forming the compositions, and methods for using the compositions are provided. In one embodiment, the composition includes at least a binding agent. The composition may be in the form of an emulsion. The compositions may be applied to an exposed surface of a substrate to suppress or mitigate fugitive dust therefrom.

### RELATED APPLICATION DATA

This application claims benefit to U.S. Provisional Application No. 61/521,220, filed Aug. 8, 2011, of which the entire contents of the application are incorporated by reference herein.

### FIELD OF THE INVENTION

The present invention relates to compositions and methods for suppressing dust. In addition the present invention relates to methods of preparing the compositions.

### BACKGROUND OF THE INVENTION

Fugitive dust is a type of non-point source air pollution composed of small airborne particles that do not originate from a specific point. Fugitive dust originates in small quantities over large areas resulting in loss of product as well as a being a suspected source of detrimental health effects. The problems of fugitive dust are well known and encountered throughout the coal handling industry, such as at the mine, at transfer points, and at utilities or at other points of utilization, and throughout the constructions industries. The problem may be compounded as a result of the close proximity of transfer points and utilities to populated or environmentally sensitive areas. Similar fugitive dust issues have been noted in the building and road construction and agricultural industries.

Conventional dust suppression systems include both mechanical and chemical methods. For instance, dust collection equipment includes devices which capture entrained dust, induce the dust to settle, or contain the dust. The most common dust suppression method, however, is the wetting of coal with water. Water is inexpensive and large quantities can be applied to eliminate dust. However, water's effectiveness as a dust suppressant has been observed to be less than satisfactory, especially in light of increasing regulation by environmental agencies.

Additionally, the addition of water decreases the specific heating value of the coal. Unrelated to the issue of reducing coal dust, it is also desirable to improve the complete combustion of coal in view of prior suppressants, such as water.

In addition to water alone, other aqueous additives have been used to suppress dust. These include solutions containing surfactants or are in the form of aqueous foams. Still further, aqueous compositions comprising asphalt emulsions or other organic coating materials may be used. It is also known to apply oils and resins to reduce or eliminate dust. Oil spraying includes the use of crude, residual, waste or fuel oils. Other liquids that may be applied to the coal to reduce dust include both synthetic and natural polymers. For instance, plant-material-containing liquids including sugar and sugar-related products are known. Polymers that collect or stick to the dust particles have also been used as suppressants. Unfortunately, such prior additives have all been observed to have a less than desirable effectiveness in dust suppression.

Accordingly, there is a need for compositions which are useful in suppressing dust, in particular coal dust, and in methods for applying such compositions.

### SUMMARY OF THE INVENTION

Embodiments of the invention are directed to compositions for dust suppression (dust suppressant compositions). The compositions include at least a binding agent. The compositions may be in the form of an emulsion.

In one aspect of the invention, a composition is provided for dust suppression to a substrate, the composition including a polyvinyl-containing binding agent and a filler material. The composition may further include a hydrocarbon wax, a surfactant, water, or a combination thereof.

In another aspect of the invention, a method is provided for applying a composition including providing an emulsion comprising a polyvinyl-containing binding agent, an organic filler, and water, providing a substrate having an exposed surface, and applying the composition to the exposed surface of the substrate. The composition may further include a hydrocarbon wax, a surfactant, water, or a combination thereof.

In another aspect of the invention, a method is provided for forming an emulsion including providing a polyvinyl-containing binding agent, providing a filler material, water, and mixing the polyvinyl-containing binding agent and the filler material component with agitation. The method may further include providing a hydrocarbon wax, a surfactant, or a combination thereof.

In another aspect of the invention, an emulsion is provided for dust suppression of a substrate including a hydrocarbon wax, a binding agent, and water. The emulsion may further comprise one or more components selected from the group of a surfactant, a defoamer, a biocide, a neutralizer, an initiator for emulsion polymerization reactions, a binder material, and combinations thereof.

In another aspect of the invention, a method is provided for applying an emulsion including providing an emulsion comprising a hydrocarbon wax and a binding agent, providing a substrate having an exposed surface, and applying the emulsion to the exposed surface of the substrate.

In another aspect of the invention, a method is provided for forming an emulsion including providing a hydrocarbon wax component, providing a binding agent component, and mixing the hydrocarbon wax component and the binding agent component with agitation.

### DETAILED DESCRIPTION OF THE INVENTION

The present invention provides compositions that are useful in imparting dust suppression to substrates, such as fugitive dust sources, processes for forming the compositions, and processes for applying the compositions. Fugitive dust is known in the respective industries, and is further defined herein as particles lifted into the air by man-made and natural activities, such as the movement of soil (fields), vehicles, equipment, blasting, and the wind, and does not include emission from definable point sources, such as industrial smoke stacks. The fugitive dust sources may be coal dust sources among others.

In one embodiment, the composition includes at least a binding agent. In another embodiment, the composition includes at least a binding agent and a filler material. The composition may further include a hydrocarbon wax, a surfactant, water, or a combination thereof. In another embodiment, the composition includes at least a hydrocarbon wax, a binding agent, a surfactant, and water, and is in the form of an emulsion. In another embodiment, the composition includes at least a hydrocarbon wax, a binding agent, a filler material, a surfactant, and water, and is in the form of an emulsion.

The binding agent may be a film-forming polymer. In one embodiment, the film-forming polymer may be a water-soluble polymer, a solution polymer, an emulsion of a water-soluble polymer, an emulsion of a solution polymer, and combinations thereof.

The film-forming polymer may be a polyvinyl-containing material selected from the group of polyvinyl alcohol (PVOH), polyvinyl alcohol copolymers, polyvinyl acetate (PVA), polyvinyl acetate copolymer (PVAc), and combinations thereof An example of a suitable polyvinyl-containing material is polyvinyl acetate-ethylene copolymer. Examples of other suitable polyvinyl acetate copolymers are neodecanoic acid ethenyl ester polymers with ethenyl acetate, acetic ethenyl ester polymers with ethenyl acetate, and combinations thereof. One example of a polyvinyl acetate aqueous solution is Adesivo PEK 4000 (PVAc) solution, commercially available from Momentive Specialty Chemicals Inc., of Columbus, Ohio. One example of a polyvinyl acetate-ethylene compound is VINNAPAS™ 465 solution having a concentration of 66% to 68% polyvinyl acetate-ethylene in an aqueous solution, and is commercially available from Wacker Chemie AG of Munich, Germany. When the binding agent comprises polyvinyl acetate (PVA), polyvinyl acetate copolymer (PVAc), or combinations thereof, the binding agent may comprise from about 5% to about 50%, such as from about 6% to about 42%, for example, from about 35% to about 42% or from about 6% to about 20%, by weight based on the total weight of the composition.

When the polyvinyl-containing material comprises a polyvinyl alcohol, the polyvinyl alcohol or polyvinyl alcohol copolymer may be present in the composition or emulsion in an amount from about 0.01% to about 5% by weight, such as about 0.05% to about 2.5%, for example, at about 0.12%, based on the total weight of the composition or emulsion. The polyvinyl alcohol may be hydrolyzed at greater than 85%, such a greater than 95%, for example hydrolyzed from about 98% to 99% from a polyvinyl acetate base material. The polyvinyl alcohol may be in the form of a solid or an aqueous solution, for example, polyvinyl alcohol (PVOH) may be provided in an aqueous solution of 20% PVOH, for example, in CELVOL™ 103, commercially available from Seikisui Inc, of Japan. The CELVOL™ 103 solution is a substantially hydrolyzed vinyl acetate copolymer at a concentration of equal to or greater than 92% and a percent hydrolysis equal to or greater than 87%, for example, from abut 98 to about 98.8%. CELVOL™ 502 is a partially hydrolyzed vinyl acetate copolymer at a concentration of >92% and a percent hydrolysis between 87-89%, which is provided in an aqueous solution of 20% PVOH.

Suitable polyvinyl-containing materials may have a viscosity from about 2 to about 6, such as from about 3.5 to about 4.5. The polyvinyl-containing materials may have a pH from about 4.5 to about 6.5. The polyvinyl-containing materials may have a specific gravity from 1.2 to 1.4 such as from 1.27 to 1.31. The polyvinyl-containing materials may have a melting point from 160° C. to 200° C.

The filler material may be a material selected from the group of an organic filler, an inorganic filler, and combinations thereof The organic filler may be a naturally occurring filler including ground or crushed nut shells, ground or crushed seed shells, ground or crushed fruit pits, processed wood, ground or crushed animal bones, or a combination comprising at least one of the naturally occurring fillers, and which may be in the form of a flour. Suitable organic fillers are selected from the group of crushed or ground walnut, crushed or ground pecan, crushed or ground almond, crushed or ground ivory nut, crushed or ground brazil nut, or a combination comprising at least one of the foregoing nuts. Other examples of suitable organic materials are crushed and ground seeds of plum, crushed and ground seeds of peach, crushed and ground seeds of cherry, crushed or ground olive hulls, crushed and ground seeds of apricot, ground or crushed seed shells maize, processed wood materials from oak, hickory, walnut, poplar and mahogany trees that have been processed by grinding or chipping. An example of an organic filler is an organic walnut shell flour filler sold under the name Wil-Fil, and is commercially available from Willamette Valley Co. of Pineville, La. The organic filler may be present in the composition in an amount from about 1% to about 40%, such as from about 15% to about 35%, for example, from about 22% to about 27%, by weight of the composition.

Alternatively, the filler may be an inorganic filler. The inorganic filler may be a compound selected from the group of silica flour, talc, and combinations thereof. The inorganic filler may be present in the composition in an amount from about 1% to about 40% by weight of the composition.

The composition may further include a hydrocarbon wax. Hydrocarbon waxes useful in making the various embodiments of the present invention may be selected from any of the commercially known hydrocarbon waxes. The hydrocarbon waxes may comprise from about 5% to about 50%, such as from about 5% to about 40%, by weight, for example, from about 5% to about 15% or from about 25% to about 45%, by weight of the total weight of the composition

Alternatively, in a composition comprising a binding agent and a hydrocarbon wax, the composition may be free of a filler material. For example, as shown in Examples 5 and 6. In such embodiment, the hydrocarbon waxes may comprise from about 5% to about 50%, such as from about 25% to about 45%, by weight of the total weight of the emulsion

Suitable hydrocarbon waxes include waxes which have a melting point of about 130° F. (about 54° C.) or greater, such as from about 130° F. to about 165° F. (about 54° C. to about 74° C.), such as from about 130° F. to about 150° F. (about 54° C. to about 66° C.), for example from about 135° F. to about 145° F. (about 57° C. to about 63° C.). The waxes may also have a flashpoint temperature of about 400° F. (about 204° C.) or greater, such as about 450° F. (about 232° C.) or greater, for example from about 400° F. (204° C.) to about 550° F. (about 287° C.). Such waxes are typically of low volatility, exhibiting less than about a 30% loss, such as from 0.1% to 30% loss, in weight during standard thermogravimetric analysis. Also, the oil content of these waxes is typically less than about 20% by weight, preferably less than about 15% by weight, such as from about 5% to less than 15 wt %.

The hydrocarbon wax may be a petroleum based wax, such as a paraffin wax. Suitable paraffin waxes may be selected from the group of slack waxes, scale waxes, folly refined waxes, and combinations thereof. The hydrocarbon wax may be a non-saponifiable wax.

The paraffin waxes may be of a relatively high molecular weight, such as a carbon chain length from twenty-six carbon atoms (C26) to forty-four carbon atoms (C44) carbon atoms for paraffin waxes, for example, having an average chain length from C26 to C38, for example, from C32 to C34 carbon chain length. Paraffin waxes are typically derived from petroleum oil distillates and are predominantly straight chain hydrocarbons.

One example of a hydrocarbon wax is a paraffin wax with a congealing point of between 128° F. and 154° F., a flash point of greater than 450° F., an oil content of less than 20%, and a carbon number distribution between C26 and C38. Examples of suitable paraffin waxes include Exxon Paravan 1370, Exxon Paravan 1380, Exxon Prowax 561, Exxon Prowax 562, CASCOWAX™ EW 58LV wax, and combinations thereof, which the Exxon waxes are commercially available from Exxon-Mobil, Inc., of Baytown, Tex., and CASCOWAX™ EW 58LV is available from Momentive Specialty Chemicals Inc., of Columbus, Ohio.

The hydrocarbon wax and film forming polymer may be combined at a weight percent ratio of hydrocarbon wax to film forming polymer from about 95:5 to about 70:30, such as from about 87:13 to about 75:25, for example, about'73:27 or about 86:14, by weight percent ratio.

Alternatively, the hydrocarbon wax and film forming polymer may be combined at a weight percent ratio of hydrocarbon wax to film forming polymer from about 5:95 to about 30:70, such as from about 10:90 to about 25:75, by weight percent ratio.

Without being bound to any specific theory, it is believed that the hydrocarbon wax emulsion provides a hydrophobic wax solid that is effectively modified by the inclusion of the binding agent, such as polyvinylalcohol or polyvinyl acetate, which provides cross-linking with the hydrocarbon wax to provide elasticity, pliability, penetration, and wet strength to the formed film.

The composition may comprise water, which may form an emulsion based on the components of the composition. The water may be present in the composition in an amount from about 15% to about 80%, such as from about 30% to about 75%, by weight based on the total weight of the composition. The composition may be applied with the compositions or emulsions described herein or in a diluted form.

A surfactant may be added to the composition. The surfactant may be added to the hydrocarbon wax, the film forming polymer, or both to help form an emulsion. The surfactant may be an anion, a cationic, a non-ionic surfactant, and combinations thereof, of which an anionic surfactant is preferred. The surfactant may comprise from about 0.1% to about 4%, such as from about 0.2% to about 3%, by weight based on the total weight of the emulsion.

The surfactant may include cationic surfactants. The surfactant may include a compound selected from the group of polynaphthalenesulfonic acid (including condensates), a lignosulfonate (including condensates), and combinations thereof. An example of a polynaphthalenesulfonic acid ionic dispersant is DISAL™ surfactant from Handy Chemicals Limited Corporation of Canada. An example of a lignosulfonate ionic dispersant, lignosulfonic acid sodium salt, is POLYFON™ H surfactant commercially available from MeadWestvaco Corporation of Richmond, Va.

Alternatively, the surfactant may be formed from the combination of an acid component and a caustic component. Suitable acid components include fatty acids having a total carbon content from eight to twenty-four carbon atoms (C8 to C24), of which fatty acids having a total carbon content of C18 being most preferred. Examples of suitable fatty acids include catrrlic acid, lignsenoic acid, stearic acid, oleic acid, linolinic acid, and combinations thereof. Suitable caustic components include amine based compounds and hydroxides, such as metal hydroxides. Examples of suitable caustic components include triethanolamine (TEA), diethanolamine, morpholine, 2-amino-2-methyl-1-propanol (AMP), potassium hydroxide, magnesium hydroxide, sodium hydroxide, and combinations thereof. In one example, the surfactant is formed from triethanolamine and stearic acid.

Additional components including a defoamer, a biocide, a neutralizer, an initiator for emulsion polymerization reactions, a binder material, and combinations thereof, may also be used with the compositions described herein.

The composition may include a defoamer. Suitable defoamers may be oil, water, silicone, or ethylene oxide/propylene oxide based and may include wax, hydrophic silica, silicone glycol, polyethylene glycol and combinations thereof. One example of a defoamer is Dehydran 111, commercially available from Cognis of Monheim, Germany. Another example of a defoamer is a silicone defoamer, such as DA11, commercially available from Troykyd Troy Chemical Corporation of Newark, N.J. The defoamer may comprise from about 0.001% to about 1.0%, such as from about 0.01% to about 0.1%, by weight based on the total weight of the composition.

The composition may further include a neutralizer. An example of a neutralizer is sodium bicarbonate. The neutralizer may comprise from about 0.01% to about 0.1%, such as from about 0.03% to about 0.08%, by weight based on the total weight of the composition.

The composition may further include an initiator for emulsion polymerization reactions. An example of the initiator is potassium persulfate. The initiator may comprise from about 0.01% to about 1.0%, such as from about 0.01% to about 0.1%, by weight based on the total weight of the composition.

The composition may further include a second binding agent. An example of a second binding agent is a vinyl acetate-acrylic binder material. An example of vinyl acetate-acrylic binder material is PolyCo B-20 binder commercially available from Momentive Quimica do Brasil, of Brazil. The secondary binder material may comprise from about 1.0% to about 20.0%, such as from about 5% to about 10%, by weight based on the total weight of the composition.

An optional component for the compositions described herein includes a biocide, which may also be referred to as a preservative. The biocides disclosed herein are useful for killing or inhibiting the biological growth of, for example, molds, mildew, slimes, fungi, bacteria, algae, and other microorganisms, on substrate products. As used herein biocides includes such compounds as bactericides, fungicides, algaecides, mildewcides, or a combination thereof.

Examples of biocides include, but are not limited to, chlorinated hydrocarbons, organometallics, halogen-releasing compounds, metallic salts, organic sulfur compounds, and phenolics. Preferred biocides have the general structure of a heterocycle containing nitrogen and sulfur, for example, thiabendazole [2-(4-thiazolyl)-1H-benzimidazole]. Another example of a biocide is Mergal biocide, commercially available from Supreme Chemicals, Inc., of Cumming, Ga. Additional suitable biocides (preservatives) include the compositions disclosed in U.S. Pat. No. 3,370,957 to Wagner et al., and U.S. Pat. No. 7,294,189 to Wantling which are incorporated in their entirety herein.

In one embodiment, the biocide is added as the last ingredient in the composition. The biocide may be present in the composition in an amount of 0.01 to 10% by weight of the composition (wt. %), such as from 0.1 to 5 wt. %, for example, 0.2 to 4 wt. %. The biocide may be added in any convenient form, including 100% solids, as a hydrated paste or in a water diluted system, for example, 25-50% active thiabendazole. The biocide is preferably added with agitation, which is believed to thoroughly disperse the biocide into the composition. Optionally, one or more of the biocides may employed in an amount calculated to be about 0.0025% to about 0.2% by weight of the final product. The biocide may be post-added to the composition under severe agitation to any desired composition where the water phase is the continuous phase in amounts ranging from 0.01 to 5% (percent) by volume.

The compositions of the present invention have been observed to have desirable properties. The compositions formed herein exhibited a pH of less than 10, such as from about 4.0 to about 9.5, for example, from about 4.25 to about 9.5. The compositions may have a viscosity from about 1 cps to about 2000 cps, such as from about 50 cps to about 1700 cps. Additionally, the typical mean solids content of the compositions of the invention have been observed to be at least 35% by weight, such as from about 38% to about 60% by weight, for example from about 44% to about 56% by weight, of the composition. Further, the compositions of the invention have been observed to have a specific gravity of about 1.5 or less, such as from about 0.90 to less than 1.2, for example, from about 0.95 to about 1.2.

Additionally, the wax-containing compositions described herein were observed to provide about 18,000 British Thermal Units (BTUs) per pound, which in the case of coal dust, providing about 12,000 BTU, per pound, could increase the overall BTU of the substrate material to which it is applied, for example, by 0.6% for the coal dust described herein. The polyvinyl containing materials may also provide over 10,000 BTUs per pound to the coal dust substrate.

In one embodiment of the composition and formation processes described herein for the polyvinyl based composition, water is first added to the reactor. Next, the polyvinyl based material, such as polyvinyl acetate ethylene copolymer is added to the reactor. Then, if a surfactant is used, the surfactant is added to the reactor. If used, agitation may be started at this time. The filler material described herein may then be added to the reactor. Agitation may be used until a homogenous dispersion is obtained. All of the process steps may be performed at ambient conditions, such as at about room temperature, from about 20° C. to about 22° C. (about 68° F. to about 72° F.).

In one embodiment of the composition and formation processes described herein for a wax emulsion, the chemical composition is the combination of two separate and individual product components that are added together to form a functional solution. The combined components are then heated to and held from about 150° F. to about 200° F., under agitation until homogeneous. After which the combined components are introduced through a high pressure homogenizer at a pressure of between 1200 and 2800 psi, cooled, for example, to about 80° F., to form the product component.

In one embodiment, the first product component is the base hydrocarbon wax emulsion, which may be optionally combined with one or more surfactants. The base hydrocarbon wax may comprise 54 percent of a paraffin wax with a congealing point of between 128° F. and 154° F., a flash point of greater than 450° F., an oil content of less than 20% and a carbon number distribution between C26 and C38. The base hydrocarbon wax may then be combined with water and the surfactants described herein. The combined components are then heated to and held at about 180° F., under agitation until homogeneous. After which the combined components are introduced through a high pressure homogenizer at a pressure of between 1200 and 2800 psi, cooled, for example, to about 80° F., to form the first product component.

The second product component is the film forming polymer, which may be in the form of a solid (powder) or an aqueous solution. For example, second component may be a solution of Poly Vinyl Alcohol (PVOH) prepared by adding by volume 20 percent of a powdered PVOH to 80 percent water. The solution is stirred until the PVOH is dissolved after which the solution is heated to approximately 185° F. under agitation until the heated solution reaches a gellation state (rheology change) and becomes clear and then cooled to ambient. Alternatively, a polyvinyl acetate copolymer aqueous solution as described herein, for example, Example 1, may be used for the PVOH solution formed above.

The first and second product components are mixed under agitation. The final finished composition, in one example, may consist of about 70 percent of the first product component of the base hydrocarbon wax emulsion with about of the 30 percent of the second product component of the binding agent.

The compositions described herein may be made from other processes, such as ‘solution polymerization’, which all of the components are brought together in a high pressure reactor and are mixed under pressure and heat to form a unique solution.

The composition described herein may be applied to suppress dust on substrates, which may also be referred herein to as dust source substrate. The composition may be disposed on the substrate, and may be applied to be continuously or semi-continuously disposed on the substrate. The composition may be applied to one or more substrates, such as for coal contained in a coal car. Suitable substrates to which the composition can be applied include coal (and coal dust), mined materials including ores and minerals, roads, harvested and non-harvested agricultural crops, fields, charcoal, and combinations thereof For example, in one embodiment, the compositions may be applied to a substrate of coal as a coal dust suppressant. The composition described herein may also be used as a topical spray on automobiles as a proactive coating for shipment.

The chemical composition described herein may be applied to a dust producing substrate or substrates, such as coal which produces coal dust. The composition may be applied to the exposed surfaces, such as a top surface, of the substrate, such as coal, by applying the compositions or emulsions described herein by a spraying technique, a misting technique, a poring technique, or combinations thereof, to the exposed surfaces of the substrate. The composition or emulsions described herein are applied to provide sufficient dust suppression. The composition or emulsions described herein may be diluted prior to application to coal dust, and may be diluted with water at a mass ratio of water to composition or emulsion from about 2:1 to 30:1, for example, from about 2:1 to 3:1, or such as from about 5:1 to 25:1, for example from 17:3 to 19:1.

In one embodiment, the composition may be applied to provide from about 10 square feet to about 110 square feet, for example from about 25 square feet to about 110 square feet or from about 27 square feet to about 110 square feet, of surface coverage per gallon of liquid composition applied respectively. After application the compositions described herein may be dried or otherwise treated for effective application to the substrate.

In order to provide a better understanding of the present invention including representative advantages thereof, the following examples are offered.

### EXAMPLES

### Example 1

A first composition may be formed by the addition of a 66 to 68% polyvinyl acetate ethylene copolymer aqueous solution, VINNAPAS™ 465 solution, and an organic filler, Wil-Fil™ filler. The two components are combined and mixed with a surfactant, the polynaphthalenesulfonic acid Disal™ surfactant, and then processed through a homogenizer or a high speed mixer. The resulting composition may comprise:

polyvinyl acetate ethylene copolymer of 39.9% by weight

walnut shell flour of 25.0% by weight,

polynaphthalenesulfonic acid of 0.2% by weight, and

about 34.9% by weight water.

The composition was analyzed, and the composition was observed to have a pH of about 4.7 to about 5.0, a viscosity from about 500 cps to about 850 cps, a solids content from about 51% to about 54% by weight, with a specific gravity from about 0.98 to about 1.15.

### Example 2

A second composition in the form of an emulsion was formed from the composition of Example 1 by the addition of 10% of a hydrocarbon wax emulsion, CASCOWAX™ EW 58LV wax emulsion, and 90% of a polyvinyl acetate ethylene composition of Example 1. The two components are combined and mixed then processed through a homogenizer or a high speed mixer. The resulting emulsion may comprise:

polyvinyl acetate ethylene copolymer of 35.9% by weight

walnut shell flour of 22.5% by weight,

polynaphthalenesulfonic acid of 0.18% by weight

a hydrocarbon slack wax of 10.0% by weight, and

about 31.4% by weight water.

The emulsion was analyzed, and the emulsion was observed to have a pH from about 5.0 to about 6.0, a viscosity from about 1200 cps to about 2000 cps, a solids content from about 51 to about 54% by weight, with a specific gravity of about 0.95 1.05.

### Example 3

A third composition may be formed by the addition of a 66 to 68% polyvinyl acetate ethylene copolymer aqueous solution, VINNAPAS™ 465 solution, and organic filler, Wil-Fil™ filler. The two components are combined and mixed with a Disal™ surfactant, and then processed through a homogenizer or a high speed mixer. The resulting composition may comprise:

polyvinyl acetate ethylene copolymer of 41.68% by weight

walnut shell flour of 26.11% by weight,

polynaphthalenesulfonic acid of 0.21% by weight, and

about 32.0% by weight water.

The composition was analyzed, and the composition was observed to have a pH from about 4.5 to about 5.5, a viscosity from about 850 to about 1000 cps, a solids content from about 53% to about 55% by weight, with a specific gravity from about 1 to about 1.2.

### Example 4

A fourth composition may be formed by the addition of about 54 to about 56% polyvinyl acetate ethylene copolymer aqueous solution, VINNAPAS™ EP 7000 (EP 441) solution, and organic filler, Wil-Fil™ filler. The two components are combined and mixed with a Disal™ surfactant, and then processed through a homogenizer or a high speed mixer. The resulting composition may comprise:

polyvinyl acetate ethylene copolymer of 40.46% by weight

walnut shell flour of 26.11% by weight,

polynaphthalenesulfonic acid of 0.21% by weight, and

about 33.2% by weight water.

The composition was analyzed, and the composition was observed to have a pH of about 4.25 to about 4.75, a viscosity of about 1200 to about 1700 cps, a solids content of about 54 to about 56% by weight, with a specific gravity of about 0.95 to about 1.1.

### Example 5

A fifth composition in the form of an emulsion was formed by the addition of 70% of a hydrocarbon wax emulsion, such as CASCOWAX™ EW 58LV wax emulsion, and 30% of a polyvinyl acetate copolymer aqueous solution, such as Adesivo PEK 4000 (PVAc) solution. The two components are combined and mixed then processed through a homogenizer or a high speed mixer. The resulting emulsion may comprise:

polyvinyl acetate copolymer of 14.1% by weight

a hydrocarbon slack wax of 38.2% by weight,

triethanolamine stearate of 2.42% by weight,

sodium bicarbonate of 0.05% by weight,

a silicone defoamer of about 0.01% by weight, and

about 45.22% by weight water.

The emulsion was analyzed, and the emulsion was observed to have a pH from about 7.5 to about 9.5, a viscosity from about 50 cps to about 350 cps, a solids content of about 54%, with a specific gravity of about 0.950.

### Example 6

A sixth composition in the form of an emulsion may be formed by the combination of 70% hydrocarbon wax emulsion, such as CASCOWAX™ EW 58LV wax emulsion, and 30% polyvinyl alcohol (PVOH). The 30% polyvinyl alcohol additional may be in the form of a CELVOL™ 203 solution, which is a 20% solution of PVOH. The two components are combined and mixed then processed through a homogenizer or a high speed mixer. The resulting emulsion may have a emulsion (Emulsion 6) comprising:

polyvinyl alcohol of 6% by weight,

a hydrocarbon slack wax of 38.2% by weight,

triethanolamine stearate of 2.42% by weight,

a silicone defoamer of about 0.01% by weight, and

about 53.38% by weight water.

The emulsion was analyzed, and the emulsion was observed to have a pH from about 8 to about 9.5, a viscosity from about 50 cps to about 300 cps, a solids content of about 44%, with a specific gravity of 0.963. Emulsion 6 may include by-products of less than 0.1% by weight.

### Example 7

Coal Dust Suppression

The compositions of Example 1, 2, 5 and 6, which are referred herein as Composition 1 and Emulsions 2, 5, and 6 respectively, were placed through a series of tests to compare the respective dust suppression data results and were further compared with water as a control. The tests are described as follows and test results are shown in Table 1. Composition 1 was diluted with water at a ratio of water to composition of 18:2 for testing with the following results. Emulsion 2 was diluted with water at a ratio of water to composition of 17:3 for testing with the following results. Emulsions 5 and 6 were diluted with water at a ratio of water to composition of 1:2.75 and 1:2.2 respectively, to provide for about 20% solids for testing with the following results. All of the compositions and emulsions were evaluated at an application rate of 20 gallons per 500 square feet (ft²) (464,500 cm²), or about 25 ft² (23,200 cm²) per gallon.

For Table 1, the data results are explained as follows. For Stress Resilience, “High” indicates that little or no effects counter to dust mitigation were observed after exposure to a give stress factor. “Low” reflects that little or no dust suppression effectiveness was experienced before the stress was applied. “Moderate” indicates that some degree of negative impact was produced by the stress, yet some redeeming qualities of the treatment persisted or developed.

For Treatment, “Room Dried” indicates treatment characteristics after drying at room temperature (15-30° C.) and relative humidity (20-65%) for about 24 hours. “Oven Dried” indicates treatment characteristics after drying in a 100° F. drying chamber for an additional about 24 hours. “Water” indicates that the chemical treatment did not differ discernibly in appearance and texture from a water treatment reference. “Viscous” indicates moist treatment that adhered to and coated the coal surfaces to a greater degree than water-only treatments. “Pliable” indicates that the treatment became a continuous and pliable shell.

For the Sloped Application, in the “Chem. Run-off” row and “Rainfall Absorbed” row, “Low” indicates that less than 15% of the total application weight fit into a given category and “Medium” indicates that between 15% and 85% of the total application fit into the given category. In the “Rain Erosion” row, “Low” indicates that less than 5% of the total application weight fit into a given category and “Medium” indicates that between 5% and 15% of the total application fit into the given category

The coal dust used for the experiments was Powder River Basin coal material. The experimental data was collected by performing the tests described herein using specialized trays with 8 compartments of varying depth, 4 for the chemical being analyzed and 4 for a water-treatment control. The depths are shown below in Table 1. The total surface area of each tray is about 1290 cm² and each compartment is 161.3 cm². The chemicals and water are applied to the trays with an electric sprayer at a pressure of 900 lbs/in². For sloped application testing, trays of tar shingle lined metal of about 1290 cm² surface area and about 1.3 cm depth are used.

TABLE 1
Test Results

| | | | | | Water |
|---|---|---|---|---|---|
| | Composition 1 | Emulsion 2 | Emulsion 5 | Emulsion 6 | (Average |
| Test | Result | Result | Result | Result | Values) |
| Stress Resilience: | High | High | High | High | Low |
| “rain” | | | | | |
| Stress Resilience: | High | High | High | High | Low |
| “heat” | | | | | |
| Stress Resilience: | High | High | High | High | Low |
| “freeze” | | | | | |
| Treatment, Film | Continuous | Continuous | Viscous | Viscous | Water |
| Observation: | | | | | |
| Initial | | | | | |
| Treatment, Film | Pliable | Pliable | Pliable | Pliable | Water-bond |
| Observation: | | | | | |
| Room Dried | | | | | |
| Treatment, Film | Firm/Pliable | Pliable | Pliable | Pliable | No |
| Observation: | | | | | water-bond |
| Oven Dried | | | | | |
| Sloped | Low | Low | Low | Low | — |
| Application: | | | | | |
| Chem. Run-off | | | | | |
| Sloped | Low | Low | Low | Low | — |
| Application: | | | | | |
| Rain Erosion | | | | | |
| Sloped | Moderate | Moderate | Moderate | Moderate | — |
| Application: | | | | | |
| Rain Absorbed | | | | | |
| Run-off/Erosion | 1.5 | 1.0 | 14.2 | 3.6 | 0.4 |
| % Run-off | | | | | |
| Run-off/Erosion | 7.5 | 13.5 | 57.0* | 56.6* | 70.3 |
| % Coal | | | | | |
| Run-off/Erosion | 92.5 | 86.5 | 43.0 | 43.4 | 29.8 |
| % Liquid | | | | | |
| Rain Simulation | 19 | 34.7 | 47.7 | 35.3 | 23.7 |
| % Run-off | | | | | |
| Rain Simulation | 0.0 | 0.0 | 0.1 | 0.1 | 0.7 |
| % Coal | | | | | |
| Rain Simulation | 100 | 100 | 99.9 | 99.9 | 99.3 |
| % Liquid | | | | | |

*Much of this weight was actually dried chemical

For the Run-Off/Erosion Test, 20 gallons/500 ft² of the chemical and water at the same volume were applied to sloped surfaces at 34°. Extensive pooling and surface run-off was observed from the composition and emulsion treated samples, and little pooling or run-off was observed from the water-treated surface as the liquid was completely and immediately absorbed. “% Run-off” represents the total weigh collected run-off as a percentage of the total weight of liquid applied. “% Coal” and “% Liquid” represent the solid and liquid components of the run-off.

For the Run-Off/Erosion Test, Composition 1 was observed to have a pliable and continuous film which produced no particle movement when exposed to slight blowing, and the chemical treatment supported the weight platform plus an additional 1700 grams (P+1700). Slight blowing is performed in a wind tunnel at about 5 miles per hour wind velocity.

For the Run-Off/Erosion Test, Emulsion 2 was observed to have a pliable and continuous film which produced no particle movement when exposed to slight blowing, and the chemical treatment supported the weight platform plus an additional 1100 grams (P+1100).

For the Run-Off/Erosion Test, Emulsion 5 was observed to have a strong, thick, pliable, and continuous film which produced no particle movement when exposed to slight blowing, and the chemical treatment supported the weight platform plus an additional 500 grams (P+500).

Also, For the Run-Off/Erosion Test, Emulsion 6 was observed to have a strong, thick, pliable, and continuous film which produced no particle movement when exposed to slight blowing, and the chemical treatment supported the weight platform plus an additional 200 grams (P+200), and the corresponding comparison water-treated sample supported the weight platform plus an additional 100 grams (P+100).

For the Rain Simulation Test, 327.7 ml ( 1/10 inch) of water was applied to each tray with an electric sprayer at a rate of 2.2 inches per hour. The samples were then allowed to be dried for about 45 hours in the lab at 80° F. and 55-65% relative humidity. Extensive pooling and surface run-off was observed from the chemically-treated sample surface, and pooling and surface run-off was observed from the water-treated surface.

For the Rain Simulation Test, Composition 1 was observed to have a continuous film which produced no particle movement when exposed to slight blowing, and the chemical treatment supported the weight platform plus an additional 1700 grams (P+1700). The water-treated sample possessed a strong, continuous water bond, which produced no particle movement when exposed to slight blowing, and the water-treated sample did not support the weight platform (NP).

For the Rain Simulation Test, Emulsion 2 was observed to have a continuous film which produced no particle movement when exposed to slight blowing, and the chemical treatment supported the weight platform plus an additional 1400 grams (P+1400). The water-treated sample possessed a strong, continuous water bond, which produced no particle movement when exposed to slight blowing, and the water-treated sample did not support the weight platform (NP).

For the Rain Simulation Test, Emulsion 5 was observed to have a strong, thick, pliable, and continuous film which produced no particle movement when exposed to slight blowing, and the chemical treatment supported the weight platform plus an additional 500 grams (P+500). The water-treated sample possessed a strong, continuous water bond, which produced no particle movement when exposed to slight blowing, and the water-treated sample supported the weight platform plus an additional 300 grams (P+300).

Also, For the Rain Simulation Test, Emulsion 6 was observed to have a strong, thick, pliable, and continuous film which produced no particle movement when exposed to slight blowing, and the chemical treatment supported the weight platform plus an additional 500 grams (P+500), and the corresponding comparison water-treated sample supported the weight platform plus an additional 200 grams (P+200) with little particle movement with exposed to slight blowing.

The water-treated sample possessed a strong, continuous water bond, which produced no particle movement when exposed to slight blowing, and the water-treated sample supported the weight platform plus an additional 200 grams (P+200).

The sloped trays were then subjected to about 7.5 hours of simulated stress as described herein. Emulsion 5 was observed to have a thick, pliable, and continuous film which produced no particle movement when exposed to slight blowing, and the chemical treatment supported the weight platform plus an additional 600 grams (P+600). The water-treated sample possessed a strong, continuous water bond, which produced a moderate amount of dust when exposed to slight blowing, and the water-treated sample supported the weight platform (P), and produced a moderate amount of dust when exposed to slight blowing.

Emulsion 6 was observed to have a pliable, rubbery, and continuous film which produced no particle movement when exposed to slight blowing, and the chemical treatment supported the weight platform plus an additional 600 grams (P+600), and the corresponding comparison water-treated sample did not support the weight platform (NP) with a large amount of particle movement with exposed to slight blowing.

For the following Table 2, abbreviations are described as follows. P indicates that the treated materials supported the weight of the testing platform, which platform provides about 287 g/cm² of pressure. The following numerical values, such as “+100” are grams of weight in excess of the weight of the platform. NP indicates that the treated material was not able to support weight of platform.

TABLE 2

| | Condition | | | | |
|---|---|---|---|---|---|
| | Composition 1 | Emulsion 2 | Emulsion 5 | Emulsion 6 | |
| Test | P + grams. | P + grams. | P + grams. | P + grams. | Water |
| Static Strength | No particle | Moderate | No particle | No particle | Little or none |
| Room Dried | movement | amount | movement | movement | particle |
| | observed. | of particle | observed. | observed. | movement |
| | | movement | | | observed. |
| | | observed. | | | |
| 1.27 cm depth | P + 900 | P | P + 400 | P + 100 | P |
| 2.54 cm depth | P + 200 | P | P + 300 | P + 300 | P |
| 3.81 cm depth | P + 100 | P + 100 | P + 200 | P | P/NP |
| 5.08 cm depth | P | P | P + 200 | NP | P/NP |
| Static Strength | Moderate | Large | No particle | No particle | Large |
| Oven Dried | amount | particle | movement | movement | particle |
| | of particle | movement | observed. | observed. | movement |
| | movement | observed. | | | observed. |
| | observed | | | | |
| 1.27 cm depth | P + 700 | P + 100 | P + 500 | P + 300 | NP |
| 2.54 cm depth | P + 300 | P + 200 | P + 400 | P + 200 | NP |
| 3.81 cm depth | P + 200 | P + 100 | P + 200 | P + 200 | NP |
| 5.08 cm depth | P | P + 200 | P + 200 | P + 100 | NP |
| Static Strength | Large amount | Large amount | No particle | No particle | Large amount |
| Solar Stress | of particle | of particle | movement | movement | of particle |
| | movement | movement | observed. | observed. | movement |
| | observed. | observed. | | | observed. |
| 1.27 cm depth | P + 100 | P + 100 | P + 600 | P | NP |
| 2.54 cm depth | P + 100 | P + 100 | P + 200 | P + 200 | NP |
| 3.81 cm depth | P + 100 | P + 100 | P + 300 | P + 200 | NP |
| 5.08 cm depth | P + 100 | P + 200 | P + 300 | P + 200 | NP |
| Static Strength | No particle | No particle | No particle | No particle | Large particle |
| Freeze Stress | movement | movement | movement | movement | movement |
| | observed. | observed. | observed. | observed. | observed. |
| 1.27 cm depth | P + 700 | P + 100 | P + 300 | P + 300 | NP |
| 2.54 cm depth | P + 300 | P + 200 | P + 500 | P + 800 | NP |
| 3.81 cm depth | P + 200 | P + 200 | P + 200 | P + 1000 | NP |
| 5.08 cm depth | P + 200 | P + 100 | P + 400 | P + 500 | NP |
| Static Strength | No particle | No particle | No particle | No particle | Large particle |
| Freeze/Thaw | movement | movement | movement | movement | movement |
| Stress | observed. | observed. | observed. | observed. | observed. |
| 1.27 cm depth | P + 600 | P | P + 600 | P + 300 | NP |
| 2.54 cm depth | P + 300 | P + 100 | P + 500 | P + 600 | NP |
| 3.81 cm depth | P + 300 | P + 100 | P + 200 | P + 300 | NP |
| 5.08 cm depth | P + 200 | P | P + 200 | P + 100 | NP |

As shown above, Composition 1 and Emulsions 2, 5, and 6 had superior performance in comparison to the water treated materials. The results of the tests for Composition 1 and Emulsions 2, 5, and 6 are more fully explained as follows.

In view of the information in Tables 1 and 2, Composition 1 was observed to be quickly absorbed by the coal. After allowing the composition to be absorbed and dried, the Composition 1 treated material produced no dust when exposed to slight blowing. Composition 1 formed a firm, pliable film that was observed to have reduced bonding properties including pliability and continuousness through exposures to environmental stresses on a flat platform. The chemically-treated surfaces did support the weight platform plus additional weight during static strength measurements throughout testing on the flat application. Pliable is defined herein as the treatment became a continuous and pliable shell.

Composition 1 was also observed in conjunction with a sloped 34° surface. When applied, the composition was observed to be immediately absorbed and did not produce significant surface or sub-surface run-off. After exposure to rain stresses, the chemically-treated surface produced no dust. Following rain and solar heat stresses, most of the chemically-treated surface's dust suppressing characteristics were maintained, including pliability and continuousness. No visible particle movement was observed when exposed to slight blowing, and no visible particle movement or measurable dust and was observed from the chemical treatment during wind tunnel testing.

Thus, Composition 1 was observed to form and maintain a pliable dust reducing film that retained much of its dust suppressing characteristics and static strength were maintained when cured and exposed to simulated environmental stresses.

In view of the information in Tables 1 and 2, Emulsion 2 was observed to pool on the surface. After allowing the emulsion to be absorbed and dried, the Emulsion 2 treated material produced no dust when exposed to slight blowing. Emulsion 2 formed a pliable film that was observed to maintain much of its bonding properties through exposures to environmental stresses on a flat platform. The chemically-treated surfaces did support the weight platform plus additional weight during static strength measurements throughout testing on the flat application. Thick is described herein as a treatment layer depth of 5 mm or thicker, whether it remained moist or became solidified. Pliable is defined herein as the treatment became a continuous and pliable shell.

Emulsion 2 was also observed in conjunction with a sloped 34° surface. When applied, the emulsion was observed to be immediately absorbed and did not produce significant surface or sub-surface run-off. Following rain and solar heat stresses, most of the chemically-treated surface's dust suppressing characteristics were maintained, including pliability and continuousness. No visible particle movement and little or no measurable dust were observed from the chemical treatment during wind tunnel testing.

Thus, Emulsion 2 was observed to form and maintain a pliable dust reducing film that retained much of its dust suppressing characteristics and static strength were maintained when cured and exposed to simulated environmental stresses.

In view of the information in Tables 1 and 2, Emulsion 5 was observed to pool extensively on the surface. After allowing the emulsion to be absorbed and dried, the Emulsion 5 treated material produced no dust when exposed to slight blowing. Emulsion 5 formed a thick, pliable film that was observed to retain pliability, strength, and continuousness through exposures to environmental stresses on a flat platform. The chemically-treated surfaces did support the weight platform plus additional weight during static strength measurements throughout testing on the flat application. Thick is described herein as a treatment layer depth of 5 mm or thicker, whether it remained moist or became solidified. Pliable is defined herein as the treatment became a continuous and pliable shell.

Emulsion 5 was also observed in conjunction with a sloped 34° surface. After exposure to rain stresses, the chemically-treated surface produced no dust. A thick, pliable film formed on the coal surface and remained throughout exposures to environmental stresses. Following solar heat stresses, the chemically-formed film seemed to increase static strength while retaining pliability and continuousness. No visible particle movement and little or no measurable dust were observed from the chemical treatment during wind tunnel testing.

Thus, Emulsion 5 was observed to form a thick, pliable, dust reducing film that retained all of its dust suppressing characteristics, including pliability, static strength, and continuousness when cured and exposed to simulated environmental stresses.

Emulsion 6 was observed to pool on the surface. After allowing the emulsion to be absorbed and dry, the Emulsion 5 treated material produced no dust when exposed to slight blowing. Emulsion 5 formed a thick, strong, and pliable film that persisted through exposure to thermal stresses on a flat application. The chemically-treated surfaces did support the weight platform during static strength measurements throughout testing on the flat application. Thick is described herein as a treatment layer depth of 5 mm or thicker, whether it remained moist or became solidified. Pliable is defined herein as the treatment became a continuous and pliable shell.

Emulsion 6 was also observed in conjunction with a sloped 34° surface. After exposure to rain stresses, the chemically-treated surface produced no dust. A thick, strong, pliable film formed on the coal surface and remained throughout exposures to environmental stresses. Following rain, solar heat, and freeze tests, the chemically-formed film seemed to increase its dust suppressing characteristics including pliability, continuity, and static strength. No visible particle movement and little or no measurable dust were observed from the chemical treatment during wind tunnel testing.

Thus, Emulsion 6 was observed to form a thick, strong, pliable dust reducing film that retained all of its dust suppressing characteristics, including pliability and continuousness when cured and exposed to simulated environmental stresses.

Water was observed to be absorbed into the coal samples with no pooling. After allowing the water to dry (Room Dried), the water treated material produced little or no dust when exposed to slight blowing. The water treated coal dust was observed to have a large amount of particle movement when exposed to slight blowing for the Oven Dried, Solar Stress, Freeze Stress, and Freeze/Thaw stress tests. The water-treated surfaces did not support the weight platform during most of the tests as shown in Table 2.

While the present invention has been described and illustrated by reference to particular embodiments and examples, those of ordinary skill in the art will appreciate that the invention lends itself to variations not necessarily illustrated herein. For this reason, then, reference should be made solely to the appended claims for purposes of determining the true scope of the present invention.

What is claimed is:

1. A composition for providing dust suppression to a substrate, comprising:
a polyvinyl-containing binding agent; and
a filler material.

2. The composition of claim 1, wherein the polyvinyl-containing binding agent is selected from the group consisting of a polyvinyl alcohol, polyvinyl alcohol copolymer, polyvinyl acetate, polyvinyl acetate copolymer, and combinations thereof.

3. The composition of claim 2, wherein the polyvinyl-containing binding agent comprises polyvinyl acetate-ethylene copolymer.

4. The composition of claim 1, wherein the polyvinyl-containing binding agent comprises from about 5% to about 50% by weight based on the total weight of the composition and the filler material comprises from about 15% to about 35% by weight based on the total weight of the composition.

5. The composition of claim 1, further comprising a compound selected from the group of hydrocarbon wax, a surfactant, water, and combinations thereof.

6. The composition of claim 5, wherein the hydrocarbon wax comprises a non-saponifiable paraffin wax selected from the group of slack waxes, scale waxes, fully refined waxes, and combinations thereof.

7. The composition of claim 5, wherein the hydrocarbon wax comprises from about 5% to about 45% by weight based on the total weight of the composition.

8. The composition of claim 5, wherein the surfactant comprises a compound selected from the group of polynaphthalenesulfonic acid, lignosulfonic acid sodium salt, and combinations thereof.

9. The composition of claim 5, wherein the surfactant comprises from about 0.1% to about 4% by weight based on the total weight of the composition.

10. The composition of claim 1, further comprising a defoamer, a biocide, a neutralizer, an initiator for composition polymerization reactions, and combinations thereof.

11. The composition of claim 5, wherein the composition comprises an emulsion having a water content from about 15% to about 80% by weight based on the total weight of the composition.

12. A method for applying a composition, comprising:
providing the composition, comprising:
a polyvinyl-containing binding agent;
an organic filler; and
water;
providing a substrate having an exposed surface; and
applying the composition to the exposed surface of the substrate.

13. The method of claim 12, wherein the substrate is a dust source selected from the group consisting of coal, roads, harvested and non-harvested agricultural crops, fields, charcoal, and combinations thereof, and combinations thereof.

14. The method of claim 12, wherein the applying the composition comprises a spraying technique, a misting technique, a pouring technique, and combinations thereof.

15. The method of claim 12, wherein the applying the composition comprises covering from about 10 square feet to about 110 square feet of surface coverage of the substrate per gallon of the composition.

16. The method of claim 12, wherein the polyvinyl-containing binding agent comprises from about 5% to about 50% by weight based on the total weight of the composition, the filler material comprises from about 15% to about 35% by weight based on the total weight of the composition, and the water comprises from about 15% to about 80% by weight based on the total weight of the composition.

17. The method of claim 12, further comprising a compound selected from the group of hydrocarbon wax, a surfactant, and combinations thereof.

18. The method of claim 17, wherein the hydrocarbon wax comprises from about 5% to about 45% by weight based on the total weight of the composition.

19. The method of claim 12, wherein the surfactant comprises from about 0.1% to about 4% by weight based on the total weight of the composition.

20. The method of claim 11, further comprising a defoamer, a biocide, a neutralizer, an initiator for composition polymerization reactions, a binder material, and combinations thereof.
